(19) United States
(12) Patent Application Publication
(10) Pub. No.: US 2024/0382299 A1
(43) Pub. Date: Nov. 21, 2024

(54) Dental Anesthetic Buffering Device

(71) Applicant: Premier Dental Products Company, Plymouth Meeting, PA (US)

(72) Inventors: Sean H. KERR, Wallingford, PA (US); Jason H. Goodchild, Berwyn, PA (US)

(73) Assignee: Premier Dental Products Company, Plymouth Meeting, PA (US)

(21) Appl. No.: 18/662,737

(22) Filed: May 13, 2024

Related U.S. Application Data
(60) Provisional application No. 63/466,473, filed on May 15, 2023.

(51) Int. Cl. A61C 19/08; A61J 1/06; A61J 1/20

(52) U.S. Cl. CPC A61C 19/08; A61J 1/06; A61J 1/201; A61J 1/2096

(57) ABSTRACT

A buffering capsule for buffering an anesthetic cartridge may include a housing including a hollow body, a closed distal end including a receptacle, and an opening opposite the closed distal end. The buffering capsule may include a buffering solution disposed within the receptacle and a flexible piston disposed within the receptacle in sealing contact with the buffering solution, wherein the flexible piston is axially movable within the housing. The buffering capsule may include a cannula holder axially movable within the housing and in contact with the flexible piston. The cannula holder may include a cannula fixedly attached to the cannula holder. The flexible piston may be capable of receiving a first sharpened point of the cannula. The buffering solution disposed within the receptacle may be fluidly connected to an anesthetic liquid in an anesthetic cartridge via the cannula. A process for buffering an anesthetic cartridge is also disclosed.

### PRIORITY CLAIM

This application is related to and claims priority to U.S. Provisional Patent Application No. 63/466,473 filed May 15, 2023, which is incorporated herein by reference.

### FIELD OF THE INVENTION

The present disclosure relates generally to dental anesthetic buffering devices that are single-use devices to provide timely buffering of a local anesthetic within a standard cartridge at chair side. This allows the local anesthetic to provide immediate relief from pain associated with dental procedures. In particular, the present disclosure relates to dental anesthetic buffering devices that are safe, effective, conserve resources, and have a long shelf life. Gas impermeable packaging for maintaining a CO₂ modified atmosphere for the device up until the time of use are also included in the dental anesthetic buffering devices of the present disclosure.

### BACKGROUND OF THE INVENTION

There is an ongoing interest in safe and effective local anesthesia options for dental clinicians to provide dental patients with pain-free dental procedures. Local anesthesia is an important part of modern dentistry. Lidocaine, having first received Food and Drug Administration approval in 1948, presented a safe and effective option to the clinician to provide pain control during complex dental procedures. Subsequently, other local anesthetic agents such as mepivacaine, prilocaine, bupivacaine, etidocaine, and articaine were introduced to further expand on the available options. Each of these agents is generally considered effective, providing a numbing effect that lasts for approximately 60 minutes within five to ten minutes of administering the injection. These anesthetics are typically provided in a liquid form that is contained in a 1.7/1.8 ml glass cartridge. The liquid is then delivered from the cartridge via a small gauge hypodermic needle in close proximity to the nerve of the dental patient.

While local anesthetics are safe and effective, current delivery options have limitations. For instance, the local anesthetic injections themselves are commonly associated with localized injection pain and will not have full onset for up to ten minutes. One of the primary reasons for the pain and slow onset is due to the acidity of the commercial anesthetic solution having a pH of from about 3 to 5. The reason the low pH is required for the anesthetic solutions is to provide shelf-life stability. However, the pH of about 3 to 5 is much lower than the human physiological pH of 7.4. The low acidity leads to a burning pain sensation during injection. Additionally, the anesthetic does not become bioavailable until the body naturally buffers it to a physiologically acceptable pH, thus creating the delay in onset time.

Clinicians have known that both the pain and delay in onset time can be addressed if the local anesthetic is alkalinized with 8.4% sodium bicarbonate solution prior to injection. This can be achieve through a “chair-side” technique whereby a 0.1-0.18 ml is withdrawn from a 50 ml vial of commercially available sterile sodium bicarbonate solution via a separate needle and syringe and then injected into the local anesthetic cartridge. While this technique is workable, it is cumbersome to employ on a routine basis. Additionally, the neutralization of a 1.7/1.8 ml only requires as little as 0.1 ml, whereby the standard sodium bicarbonate solution vial contains 50 ml. This means that 99.8% of the vial remains unused. While the remaining sodium bicarbonate could potentially be used for other patients, the vials are only intended for single patient use and the sodium bicarbonate solution is not stable once exposed to air. Additionally, the septum on the sodium bicarbonate solution vial is not intended for multiple penetrations and the potential for cross contamination increases after each use. Therefore, a majority of the sodium bicarbonate solution vial is wasted.

Companies such as OnPharma have introduced devices to facilitate easier buffering of local anesthetic cartridges (see https://www.onpharma.com/products/onset-introductory-order) which utilizes a custom, 1.8 ml glass cartridge of 8.4% sodium bicarbonate solution that is more appropriately sized for dental anesthetic neutralization. This solution is transferred to a dental local anesthetic cartridge via a pen-like device and associated disposable transfer needle in doses that can be selected by the user. While this offers case of use benefits over the manual chair-side technique, it requires the user to purchase and maintain the pen device. Multiple steps are required to set up the pen with a new sodium bicarbonate cartridge after 10-20 doses. Additionally, the sodium bicarbonate solution is not stable for more than 7 days once it is loaded into the pen and the solution is housed in a glass cartridge to maintain the shelf life stability of the sodium bicarbonate. However, this glass cartridge adds to the manufacturing cost and glass has the potential of breaking in transit or during use by the clinician creating a potential hazard.

The embodiments described herein satisfies a long-felt need for a safe and effective way to administer 0.1 ml of 8.4% sodium bicarbonate solution into a local anesthetic cartridge that avoids the waste and complexity associated with available options. The local anesthetic buffering device herein satisfies these long-felt needs and provides a sterile option that is self-contained. single use. simple to use. and is also glass-frec.

### SUMMARY OF THE INVENTION

The present disclosure relates to a buffering capsule for buffering an anesthetic cartridge including: a housing about a center axis and having a housing length, the housing including: a hollow body about a center axis, the hollow body having a first inner circumferential surface, a hollow body length, and a hollow body diameter, and a closed distal end about the center axis including a receptacle, the receptacle having a second inner circumferential surface, a receptacle length, and a receptacle diameter; and an opening opposite the closed distal end; a buffering solution disposed within the receptacle; a flexible piston disposed within the receptacle in sealing contact with the second inner circumferential surface and the buffering solution, wherein the flexible piston is axially movable within the housing toward the closed distal end; a cannula holder axially movable within the housing and in contact with the flexible piston: a cannula disposed about the center axis, the cannula fixedly attached to the cannula holder; the cannula having a cannula length less than the housing length, a first sharpened point, and a second sharpened point opposite the first sharpened point; wherein the flexible piston is capable of receiving the first sharpened point.

In some aspects, the techniques described herein relate to a process for buffering an anesthetic cartridge including: advancing a buffering capsule onto an anesthetic cartridge having a septum and containing an anesthetic liquid, the buffering capsule having a housing and a cannula axially moveable within the housing, the cannula having a first sharpened point and a second sharpened point opposite the first sharpened point; penetrating the second sharpened point into the septum to fluidly connect the cannula to the anesthetic cartridge; penetrating the first sharpened point through a flexible piston and into a receptacle containing a buffering solution to fluidly connect the cannula to the buffering solution; and advancing the buffering capsule onto the anesthetic cartridge further until the flexible piston is in contact with a closed distal end of the housing, and intermixing the buffering solution and the anesthetic liquid within the anesthetic cartridge.

### BRIEF DESCRIPTION OF THE DRAWINGS

FIG. 1A illustrates a side view of a local anesthetic buffering device, according to an exemplary embodiment, as well as a top view and a bottom.

FIG. 1B illustrates a perspective view of the local anesthetic buffering device as in FIG. 1A, according to an exemplary embodiment.

FIG. 2A illustrates the device according to FIG. 1 that is disposed onto a local anesthetic cartridge (prior to transferring sodium bicarbonate solution to the cartridge).

FIG. 2B illustrates the device according to FIG. 2A in a first position where the device pierces a local anesthetic cartridge.

FIG. 2C illustrates the device according to FIG. 2B in a second position where the device pierces a flexible piston.

FIG. 2D illustrates the device according to FIG. 2C in a third position where a buffering solution is transferred from the local anesthetic buffering device to a local anesthetic cartridge via a fluid pathway formed by a cannula.

FIG. 2E illustrates the device according to FIG. 2D in a fourth position where all of the buffering solution has been transferred from the device to the cartridge.

### DETAILED DESCRIPTION OF THE DISCLOSED EMBODIMENTS

As noted above, it is generally recognized that buffering an anesthetic improves onset efficacy, which minimizes time the patient is required to sit for a procedure. Further, buffering increases the pH of the anesthetic to mitigate or eliminate pain or burning sensation experienced by the patient associated with the injection, which is due to a pH mismatch between the anesthetic and the patient's physiological pH of 7.4.

It has been discovered that a dental anesthetic buffering device, or buffering capsule, as disclosed herein may be used safely and effectively at point-of-care to address the need for buffering while also providing a single-use solution that is disposable to eliminate cross-contamination, is glass-free, eliminates waste (of buffering solution), and may be used with a simple process with standard (already in use) anesthetic cartridges.

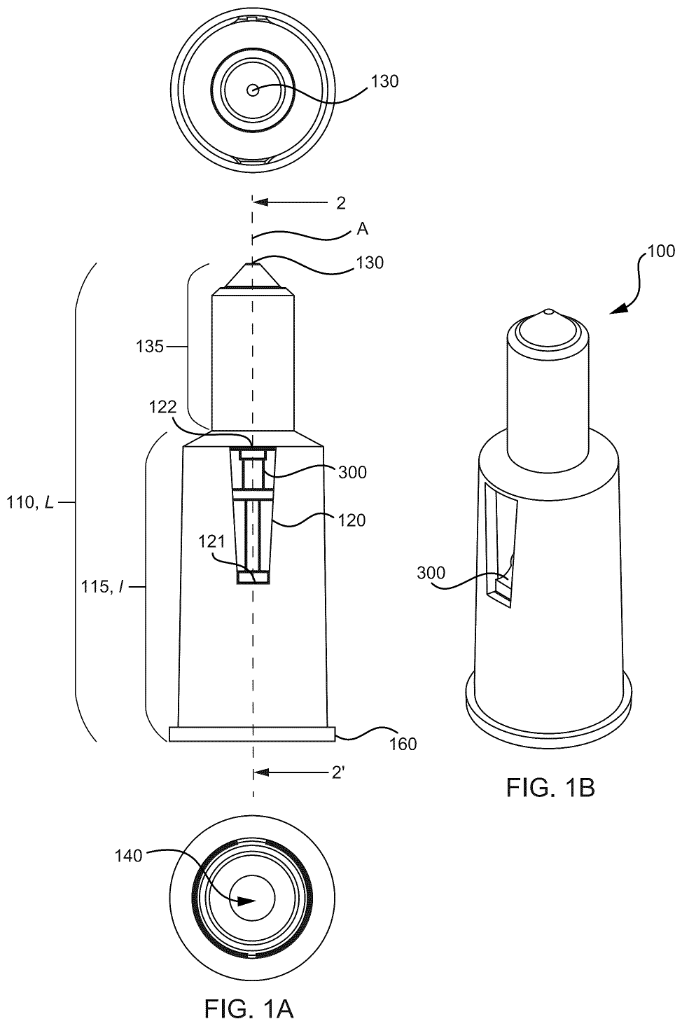

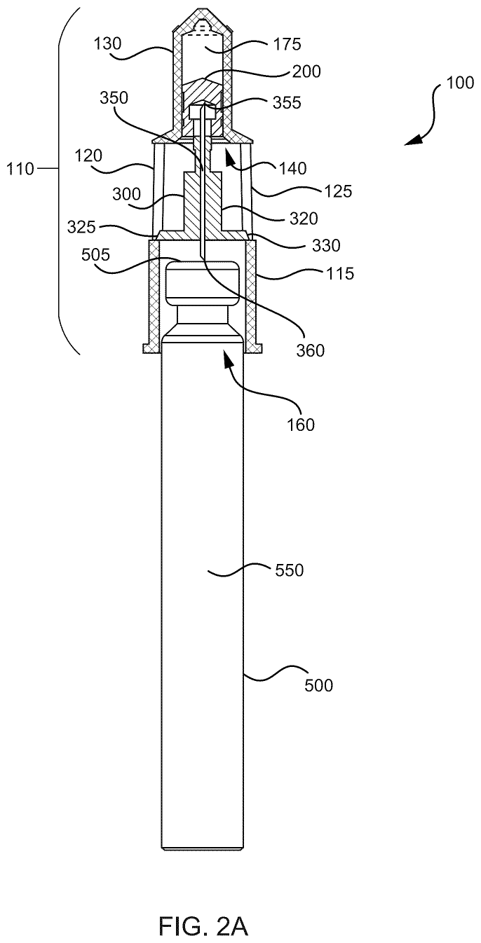

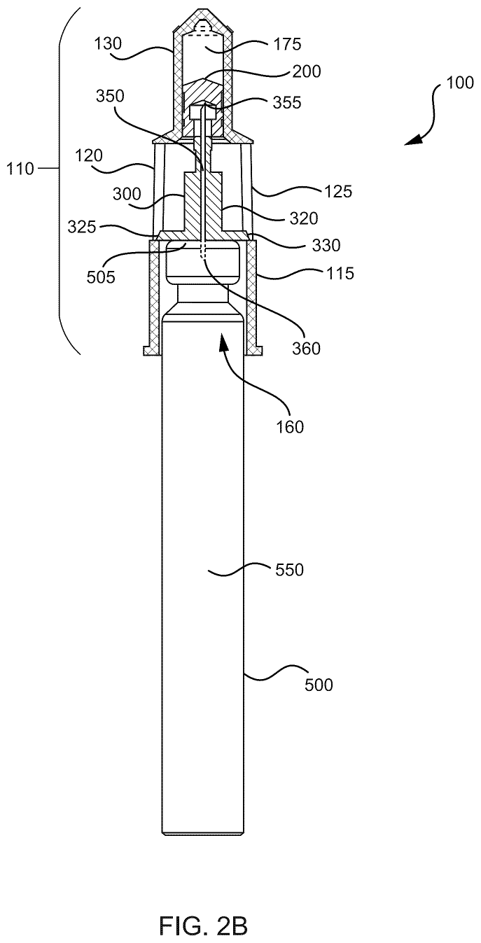

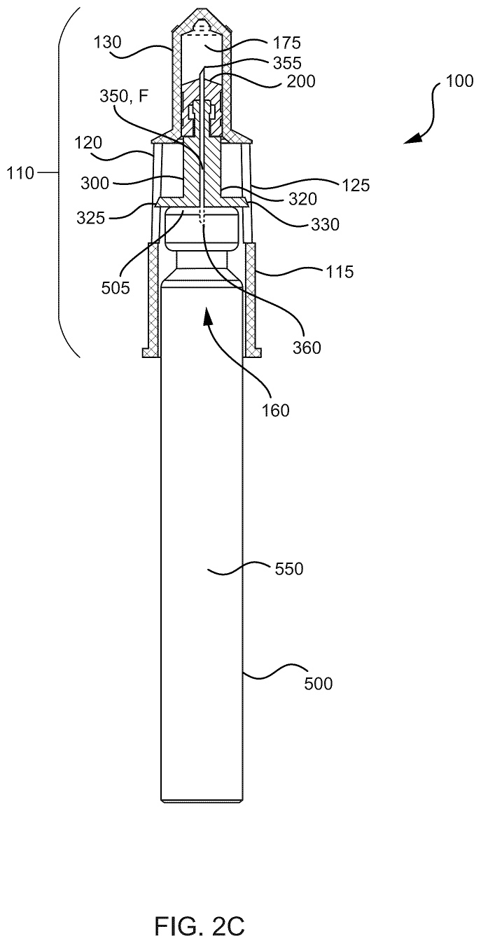

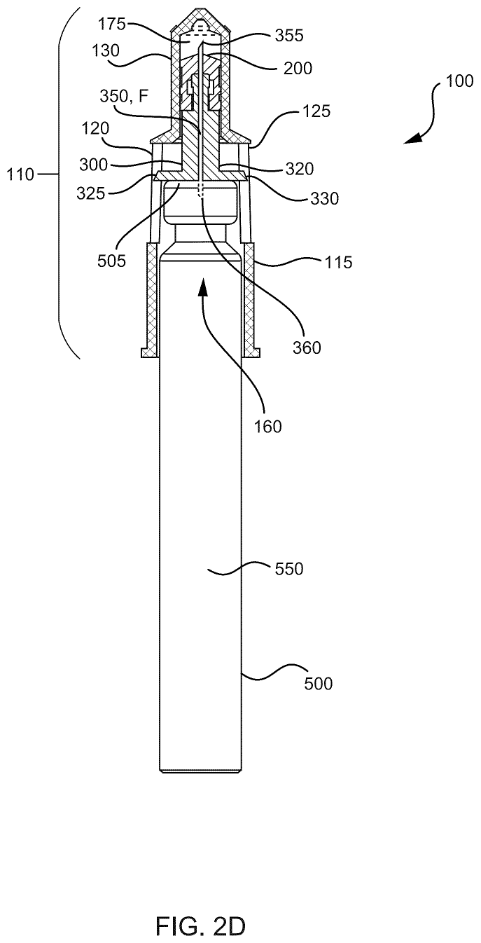

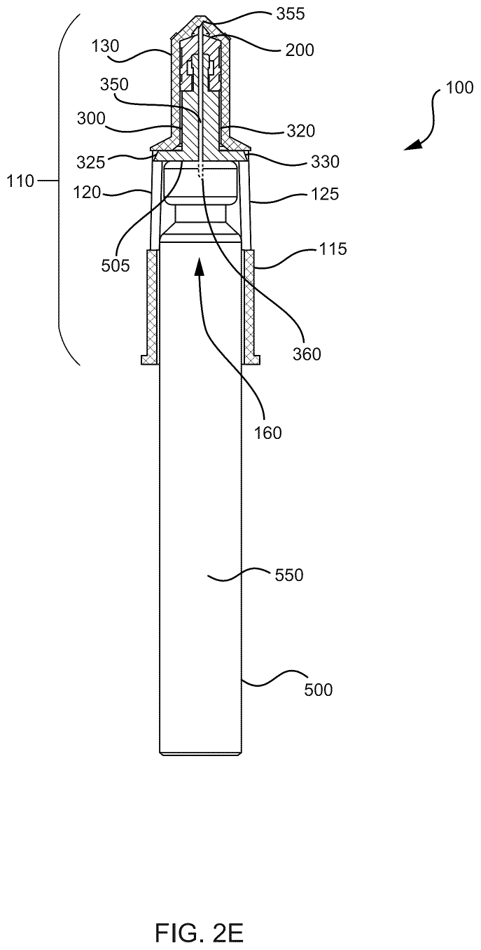

FIG. 1A and FIG. 1B illustrate a side view (and top and bottom views) and a perspective view, respectively, of a local anesthetic buffering device according to an exemplary embodiment. Local anesthetic buffering capsule 100 is also referred to as “local anesthetic buffering device”, “dental anesthetic buffering device”, “buffering device”, or simply as “device” herein. While FIG. 1B illustrates the outer contours of buffering capsule 100, FIGS. 2A through 2E illustrate the buffering capsule of the inventions shown at various states of operations until all of a buffering solution from within the buffering capsule is transferred to the anesthetic cartridge.

As shown in FIG. 1A and FIG. 1B, buffering capsule 100 includes a housing 110 having a housing length, L. Housing 110 includes a hollow body 115 about a center axis, A. Hollow body 115 has a first inner circumferential surface, a hollow body length, I, and a hollow body diameter. Housing 110 includes closed distal end 130, also concentric about axis A, and a receptacle 140 therein. The receptacle has a second inner circumferential surface, a receptacle length, and a receptacle diameter. Housing 110 further includes opening 160 at an end opposite the closed distal end 130.

Receptacle 140 contains a buffering solution 175. Buffering solution 175 is scaled within receptacle 140 by flexible piston 200, which may be a plunger or a plunger stopper. Flexible piston 200 is in sealing contact with the receptacle inner circumferential surface and the buffering solution. In the preferred embodiment, the flexible piston 200 is maintained in position from the time of manufacturing to the time of use with a vacuum between the solution and the piston. Alternatively, the piston can be maintain in position with a mechanical means including but not limited to a stop incorporated intothe receptacle or cannula holder 300 or friction. Flexible piston 200 is axially movable within the housing toward the closed distal end 130. Cannula holder 300 is axially movable within the housing 110 and in contact with the flexible piston 200.

FIG. 2A illustrates a cross-sectional view of the buffering capsule 100 according to FIG. 1 and also an anesthetic cartridge 500. FIG. 2A shows the buffering capsule 100 and anesthetic cartridge 500 prior to transferring buffering solution 175 to the anesthetic cartridge 500. Referring to FIG. 2A, a cannula 350, which is hollow having a small gauge diameter, is disposed concentrically about the center axis A and is fixedly attached to the cannula holder 300. Cannula 350 has a cannula length that is less than the length of the housing. This is important because when the capsule is not in use (not advanced onto an anesthetic cartridge), the cannula is safely within the housing and cannot poke or harm the clinician using the device.

As shown in FIG. 2A, when the buffering capsule 100 is first mounted to a standard dental local anesthetic cartridge 500, the buffering capsule receptacle 140 houses a volume, e.g., 0.1 ml, of a buffering solution, e.g., sterile 8.4% sodium bicarbonate solution. Buffering solution 175 is sealed into the capsule by a flexible piston, e.g., an elastomeric piston, which moves freely during use to translate along axis A and specifically in a direction toward the closed distal end 130, but is maintained in position during transportation

The buffering capsule 100 also includes a cannula 350 with a sharpened point on cach end that is held into place by a cannula holder that is free to translate axially. In a preferred embodiment, the cannula is a 28 gauge cannula. In other embodiments it ranges from 20-36 gauge. However, any size cannula can be utilized which will penetrate and seal around the septum on the cartridge and the piston. Cannula 350 has two sharpened points on either end: a first sharpened point 355 and a second sharpened point 360 opposite the first sharpened point. Each point is capable of piercing to penetrate either the piston 200 or the septum 505 of anesthetic cartridge 500. The flexible piston 200 e.g., an elastomeric piston, is made of an elastomeric material or the like so that flexible piston 200 is capable of receiving the first sharpened point 355. The sharpened points of the cannula are recessed into the device so as to not create a needle-stick hazard to the user while handling the buffering capsule 100.

FIG. 2B illustrates the device according to FIG. 2A in a first position where the device pierces an anesthetic cartridge 500 through septum 505. This provides a fluid pathway from the buffering capsule 100 to the anesthetic cartridge 500 via the cannula 350.

FIG. 2C illustrates the device according to FIG. 2B in a second position where the device pierces a flexible piston 200. This provides a fluid pathway, F, from the receptacle 140 to the local anesthetic cartridge 500 via the cannula 350. Therefore, the buffering solution 175 is in fluid communication with anesthetic liquid 550 via fluid pathway, F, as in FIG. 2C. In the preferred embodiment, Receptacle 140 contains a volume of solution such that amount that is transferred can be accommodated into the anesthetic cartridge without excessively displacing the plunger within the anesthetic cartridge. This amount has been previously established to be nominally 0.1 ml. It has also been previously established that this amount is sufficient to adequately neutralize dental anesthetics. Manufacturing tolerances and actual use may vary this 0.1 ml value by +/−20%. This invention is not however limited to the 0.1 ml volume, and can be made to fit any amount of fluid. In the preferred embodiment the buffering solution may be a sterile 8.4% sodium bicarbonate solution. Other buffering solutions or concentrations of sodium bicarbonate known by those with ordinary skill in the art may also be used.

FIG. 2D illustrates the device according to FIG. 2C in a third position where the buffering solution 175 is at least partially transferred from the buffering capsule 100 to anesthetic cartridge 500. The anesthetic cartridge 500 has a volume enough to accommodate all of the buffering solution 175.

FIG. 2E illustrates the device according to FIG. 2D in a fourth position where the buffering solution 175 has been fully transferred from the buffering capsule 100 to anesthetic cartridge 500.

As the progression of FIG. 2A-2E demonstrates, buffering capsule 100 includes that the cannula holder 300 is slidably connected to the housing. This may be by a snap-fit tongue and groove connection, friction fit or other mechanical means. Buffering capsule 100 first and second apertures (120, 125) in the hollow body 115 of the housing 110. Each aperture includes first and second ends (121, 122). Cannula holder 300 includes first and second extensions (325, 330) at a cannula holder base 320. The first and second extensions (325, 330) are slidably movable within the first and second apertures (120, 125) in the hollow body 115 of the housing 110.

In some embodiments, buffering capsule 100 includes wherein the cannula holder 320 is axially moveable from an initial position, where the first and second extensions (325, 330) are at first ends (121) of the first and second apertures (120, 125), to another position advanced axially in a direction toward the closed distal end 130, where the first and second extensions (325, 330) are at second ends (122) of the first and second apertures (120, 125) and the buffering solution 175 is fluidly connected via the cannula.

In aspects herein, buffering capsule 100 includes advancing positions as follows. In a first position, the first sharpened point 355 of the cannula 350 is within the cannula holder 300 and the second sharpened point 360 of the cannula 350 extends axially into the housing 110. In a second position, the buffering capsule 100 is advanced onto the anesthetic cartridge 500, the first sharpened point 355 remains within the cannula holder 300, and the second sharpened point 360 penetrates the septum 505 of the anesthetic cartridge 500. In a third position, the buffering capsule 100 is further advanced onto the anesthetic cartridge 500, the first sharpened point 355 penetrates the flexible piston 200, and the second sharpened point 360 remains penetrated into the septum 505 of the anesthetic cartridge 500, wherein the buffering solution 175 disposed within the receptacle 140 is fluidly connected to the anesthetic liquid 550 via the cannula 350. In a fourth position, the buffering capsule 100 is fully advanced onto the anesthetic cartridge 500, the flexible piston 200 is advanced to contact the closed distal end 130, the receptacle 140 is depleted of the buffering solution and the volume of the receptacle is minimized by the impingement of the flexible piston 200. In this fourth position (as illustrated in FIG. 2E), buffering solution 175 is completely intermixed the anesthetic liquid 550 within the anesthetic cartridge 500.

Buffering capsule 100 is preferably free of glass or glass components. Housing 110 of buffering capsule 100 may be a single piece that is injection molded, for example. Other manufacturing techniques are also contemplated, e.g., additive manufacturing, so long as the materials used are safe for holding and storing (until use) a buffering solution and will not leach or contaminate same. Housing 110 may be made of a plastic, e.g., polypropylene. Cannula holder 300 may also be an injection molded (or additive manufactured) plastic, e.g., polypropylene, or other suitable plastic listed above. Cannula 350 may be of any suitable gauge to create a fluid pathway. In preferred embodiments, Cannula 350 is 28 gauge. Flexible piston 200 as mentioned above is elastomeric.

Buffering capsule 100 is intended for single-use, is also disposable and has a shelf life of 90 days or more. In some embodiments, buffering capsule 100 has a shelf life of 120 days or more, e.g., 150 days, 180 days, 270 days, or 365 days. In certain cases, buffering capsule 100 has a shelf life of 1 year, 2 years, or 3 years or more.

In another embodiment, buffering capsule 100 is further sealed within a packaging such as a flexible pouch or the like, to hold one or more buffering capsules, or can be used to encase cach buffering capsule individually. Preferably the packaging, including one or more buffering capsules, includes a first carbon dioxide concentration between the packaging and the buffering capsule is higher than the concentration of carbon dioxide in the ambient atmosphere. The packaging may include gas-impermeable layers such as aluminum foil film laminated with a heat sealable layer, metalized polymer films or another suitable gas-impermeable films, e.g., plastic film that includes silicon oxide (SiO₂) for gas impermeability. Packaging is discussed further below.

Embodiments herein include a process for buffering an anesthetic cartridge. The process may include the following.

In an initial step, the buffering capsule 100 is advanced onto an anesthetic cartridge 500 having a septum 505 and containing anesthetic liquid 550. The buffering capsule has a housing 115 and a cannula 350 axially moveable within the housing. Cannula 350 has a first sharpened point and a second sharpened point opposite the first sharpened point. The process then includes penetrating one of the sharpened points into the septum 505 to fluidly connect the cannula to the anesthetic cartridge 500. In use, the user pushes and advances the buffering capsule 100 onto anesthetic cartridge 500 so that one sharpened point of the cannula pierces the septum 505 at top of the anesthetic cartridge 500 as shown in FIG. 2B. Pushing is done simply by hand pressure until the sharpened point of the cannula penetrates the septum. No special device or applicator tool is needed.

Next, the process includes penetrating the opposite sharpened point through a flexible piston 200 and into a receptacle containing a buffering solution 175 to fluidly connect the cannula 350 to the buffering solution, as by fluid pathway F as shown in FIG. 2C. In practice, the user accomplishes this by further advancing the capsule onto the anesthetic cartridge 500, the opposite end of the cannula pierces the moveable piston. At this point, the buffering solution 175, e.g., sodium bicarbonate solution, in the buffering capsule 100 is in fluid communication with the anesthetic cartridge 500, but the solution has not yet been transferred.

The process further includes advancing the buffering capsule 100 onto the anesthetic cartridge 500 further until the flexible piston 200 is in contact with a closed distal end 130 of the housing 115. This further advancement of the buffering capsule 100 onto the anesthetic cartridge 500 causes flexible piston 200 to move upwards and pressurize the buffering solution 175 within receptacle 140. This pressurization will cause the buffering solution 175 to flow into the anesthetic cartridge 500. Thus, intermixing of the buffering solution and the anesthetic liquid within the anesthetic cartridge occurs as in FIG. 2D.

Upon further advancement of the buffering capsule 100 onto the anesthetic cartridge 500, the remaining buffering solution 175 will be expressed into the anesthetic cartridge 500. Thus, the anesthetic liquid 550 is successfully neutralized to be accepted by the patient with little to no discomfort and with reduced onset time of as little as one minute or less. In this final state as shown in FIG. 2E, substantially all of the buffering solution 175 is transferred into the anesthetic cartridge 500. At this point, the transfer process is complete, and the buffering capsule can be removed from the anesthetic cartridge and discarded.

In a preferred embodiment of the device, the internal diameter of the distal end 130 is smaller than the internal diameter of the anesthetic cartridge 500. This creates an hydraulic advantage whereby the force exerted on the anesthetic plunger is less than force required to transfer the solution.

Manufacturing processes such as injection molding and additive manufacturing are suitable for making buffering capsules as described herein.

The device is manufactured from readily available materials that are utilized in the manufacture of medical devices. In embodiments herein, the housing and/or cannula holder may be made by one or more of the following: acrylics, polypropylene, polycarbonates, nylons, polyethyleneterphthalates, polyesters, polyethylenes, polystyrenes, poly lactic acid, polyhyroxyalkanoates, bioderived polyolefins including polyethylene and polypropylene and other resins known in the art that are recyclable and combinations thereof. In one embodiment, the housing and/or cannula holder may made of polypropylene.

In embodiments herein, the flexible piston if made of a medical-grade elastomeric material, e.g., rubber, silicone rubber, thermoplastic elastomers, or the like.

The materials for making the buffering capsules, or components thereof (the housing, the cannula holder, and/or the flexible piston) described herein may optionally include one or more additives selected from the group consisting of anti-oxidants, slip additives, anti-static agents, impact modifiers, a colorants, acid scavengers, X-ray fluorescence agents, radio opaque fillers, surface modifiers, processing aids including melt stabilizers, nucleating agents including clarifiers, flame retardants, inorganic fillers other than finely powdered talc, organic fillers and other polymers and reinforcing agents.

All materials are biocompatible. The cannula is preferably made from stainless steel, but could also be made from plastic and molded as part of the cannula holder.

The device can be terminally sterilized via gamma irradiation, e-beam irradiation, steam sterilization or any other appropriate sterilization technique. Alternative, the components and solution can be pre-sterilized, filled, and assembled in an aseptic manner.

One important advantage of the present device is that the buffering capsules described herein eliminate glass and other costly packaging techniques. The materials as described above are safe and are easily handled and resist breakage. Glass components are also more expensive than plastic components are more limited in terms of the features that can be created during the manufacturing process.

To address another problem as relates to handling buffering solution, e.g., sodium bicarbonate solution, as in the buffering capsules described herein, it may be advantageous to further package the buffering capsules in packaging that suppresses the following reaction as in Formula (1).

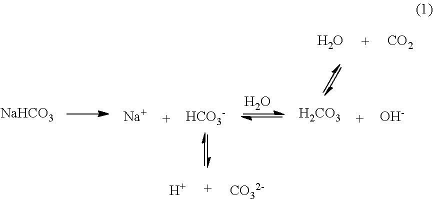

Sodium bicarbonate can convert to sodium carbonate if the CO₂ is allowed to escape. This results in a higher pH and causes the buffering solution to no longer be in the form that is required for neutralization of an anesthetic liquid. Liberation of CO₂ can be halted by packaging the sodium bicarbonate in glass containers that are gas impermeable. However, glass containers are relatively expensive, prone to breakage and are not capable of being molded into complex features as are required by the buffering capsules described herein. Thus, glass packaging is not well suited for the low cost single-use devices of the invention.

Certain plastic materials, such as polyethylene terephthalate (PET) and polyethylene terephthalate glycol (PETG), may be relatively gas impermeable as compared to other plastics such as polypropylene. Thus, PET and PETG may be used to keep the carbonation in carbonated beverage bottles, for example. However, when tested for use in the accelerated condition of 50° C., 0.1 ml of sodium bicarbonate in a PETG container did not maintain the pH of the buffering solution after a period of 21 days. The final pH was 9.7, as shown in Table 1 as Comparative Example 1, which is well above the acceptable limit and indicating that the solution has turned into the carbonate form.

To address this problem, a feature of the present invention is to package the capsule in a modified atmosphere containing CO₂ gas. The carbon dioxide concentration between the packaging and the outside of the capsule is in equilibrium with the CO₂ released from the sodium bicarbonate solution and thus there is no longer a concentration differential that allows the CO₂ to escape from the solution. The packaging itself can be a variety of gas impermeable materials for blister packaging or the like. Suitable packaging materials for encasing the buffering capsules may include films such as an aluminum foil film laminated with a heat scalable layer. Other suitable gas impermeable films include silicon oxide (SiO₂) or a metalized layer. The packaging can also include additional laminated layers to aid in printing, aesthetic presentation, durability, shelf-life, manufacturing efficiency, flexibly, case of opening and the like.

When a polypropylene capsule containing 0.1 ml of sodium bicarbonate is packaged in a CO₂ modified atmosphere in a gas impermeable package, the pH remains stable in the accelerated testing conditions as shown in Example 1 and as in Table 1 below.

### EXAMPLES

### Example 1. Buffering Capsule with CO₂ Modified Atmosphere

A buffering capsule according to the invention was prepared using 8.4% sodium bicarbonate solution and capsules made from polypropylene and PETG. A thermoplastic elastomer piston was used to seal the capsule. The polypropylene buffering capsule was packaged in a CO₂ modified atmosphere in a gas impermeable package made from an aluminum metalized film. The PETG capsules were left unpackaged and exposed to ambient storage conditions, relying only on the barrier properties of PETG to prevent the release of CO₂ gas. As shown in Table 1, the pH remained stable in accelerating testing conditions. This provides an expected shelf life of at least 5 months.

TABLE 1
pH of Sodium Bicarbonate at 50 deg C. storage

| | | Comparative Example 1 |
|---|---|---|
| Days | Example 1 | (PETG) |
| 0 | 8.0 | 8.0 |
| 1 | 7.9 | 8.4 |
| 21 | 8.0 | 9.7 |

The modified atmosphere barrier packaging in Example 1 allows for the device to be manufactured from polypropylene which is cost effective and can be readily molded into the required geometries.

The pH of the sodium bicarbonate solution can also be varied by changing the concentration of CO₂. It may be advantageous to raise the CO₂ level to extend shelf life, or lower the CO₂ level to increase the pH and thus increase the pH of the buffered anesthetic. In a preferred embodiment, the CO₂ level within the packaging at the time of manufacturing is greater than 70%.

### Example 2. Long Term Shelf Life

Devices were manufactured utilizing 0.1 ml of 8.4% sodium bicarbonate solution in a polypropylene capsule with a thermoplastic elastomer piston. The devices were then packaged individually in a CO₂ modified-atmosphere (˜90% CO₂) within aluminum foil laminate pouches. These packaged devices were then stored in an accelerated aging chamber at 60° C. to condition them to the equivalent 6, 12 and 24 months real-time.

| | Equivalent Aging (Months) | | |
|---|---|---|---|
| | 6 | 12 | 24 |
| pH of sodium bicarbonate | 7.69 | 7.75 | 7.71 |
| solution in device | | | |
| pH of buffered anesthetic | 6.83 | 6.83 | 6.89 |
| (unbuffered pH: 2.91) | | | |
| CO₂ level in packaging | 91 | 90 | 88 |

This example illustrates that the packaging is effective at maintaining the pH of the sodium bicarbonate solution over an extended period of time. Extrapolation of this data estimates that a shelf life of over 10 years would be possible before an upper limit of 8.4 pH was reached. This also illustrates the effectiveness of buffering a dental anesthetic from a low pH of 2.91 to a more physiological pH of approximately 6.8-6.9.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

While the disclosure has been described in detail, modifications within the spirit and scope of the disclosure will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the disclosure and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the disclosure.

What is claimed is:

1. A buffering capsule for buffering an anesthetic cartridge comprising:
a housing about a center axis and having a housing length, the housing including:
a hollow body about a center axis, the hollow body having a first inner circumferential surface, a hollow body length, and a hollow body diameter, and
a closed distal end about the center axis including a receptacle, the receptacle having a second inner circumferential surface, a receptacle length, and a receptacle diameter; and
an opening opposite the closed distal end;
a buffering solution disposed within the receptacle;
a flexible piston disposed within the receptacle in sealing contact with the second inner circumferential surface and the buffering solution, wherein the flexible piston is axially movable within the housing toward the closed distal end;
a cannula holder axially movable within the housing and in contact with the flexible piston:
a cannula disposed about the center axis, the cannula fixedly attached to the cannula holder, the cannula having a cannula length less than the housing length, a first sharpened point, and a second sharpened point opposite the first sharpened point;
wherein the flexible piston is capable of receiving the first sharpened point.

2. The buffering capsule of claim 1, wherein the cannula holder is slidably connected to the housing.

3. The buffering capsule of claim 2, wherein the cannula holder includes first and second extensions at a cannula holder base, where the first and second extensions are slidably movable in first and second apertures in the hollow body of the housing.

4. The buffering capsule of claim 1, further comprising a cartridge having a septum, wherein the cartridge contains an anesthetic liquid.

5. The buffering capsule of claim 4, wherein the buffering solution disposed within the receptacle is fluidly connected to the anesthetic liquid via the cannula.

6. The buffering capsule of claim 3, wherein the cannula holder is axially moveable from an initial position, where the first and second extensions are at first ends of the first and second apertures, to another position advanced axially in a direction toward the closed distal end, where the first and second extensions are at second ends of the first and second apertures and the buffering solution is fluidly connected via the cannula.

7. The buffering capsule of claim 4, wherein:
in a first position, the first sharpened point of the cannula is within the cannula holder and the second sharpened point of the cannula extends axially into the housing;
in a second position, the buffering capsule is advanced onto the anesthetic cartridge, the first sharpened point remains within the cannula holder, and the second sharpened point penetrates the septum of the cartridge;
in a third position, the buffering capsule is further advanced onto the anesthetic cartridge, the first sharpened point penetrates the flexible piston, and the second sharpened point remains penetrated into the septum of the cartridge, wherein the buffering solution disposed within the receptacle is fluidly connected to the anesthetic liquid via the cannula; and
in a fourth position, the buffering capsule is fully advanced onto the anesthetic cartridge, the flexible piston is advanced to contact the closed distal end, the receptacle is depleted of the buffering solution, and the buffering solution is intermixed the anesthetic liquid within the cartridge.

8. The buffering capsule of claim 1, wherein the buffering capsule is free of glass.

9. The buffering capsule of claim 1, wherein the buffering capsule is single-use.

10. The buffering capsule of claim 1, wherein the buffering capsule has a shelf life of 180 days or more.

11. The buffering capsule of claim 1, wherein the housing comprises injection molded plastic.

12. The buffering capsule of claim 8, wherein the housing comprises polypropylene.

13. The buffering capsule of claim 1, wherein the cannula holder comprises injection molded plastic.

14. The buffering capsule of claim 11, wherein the cannula holder comprises polypropylene.

15. The buffering capsule of claim 1, wherein the cannula is 28 gauge.

16. The buffering capsule of claim 1, wherein the volume transferred is between 0.9 and 1.1 ml and the buffering solution is a sterile 8.4% sodium bicarbonate solution.

17. The buffering capsule of claim 1, further comprising the buffering capsule sealed within a packaging, wherein the carbon dioxide concentration within the package is higher than atmospheric conditions.

18. The buffering capsule of claim 1, wherein the receptacle diameter is smaller than the inner diameter of the anesthetic cartridge.

19. The buffering capsule of claim 1, wherein the device and solution are sterilized with ionizing radiation.

20. A process for buffering an anesthetic cartridge comprising:
advancing a buffering capsule onto an anesthetic cartridge having a septum and containing an anesthetic liquid, the buffering capsule having a housing and a cannula axially moveable within the housing, the cannula having a first sharpened point and a second sharpened point opposite the first sharpened point;
penetrating the first sharpened point into the septum to fluidly connect the cannula to the anesthetic cartridge;
penetrating the second sharpened point through a flexible piston and into a receptacle containing a buffering solution to fluidly connect the cannula to the buffering solution; and
advancing the buffering capsule onto the anesthetic cartridge further until the flexible piston is in contact with a closed distal end of the housing, and
intermixing the buffering solution and the anesthetic liquid within the anesthetic cartridge.
